(19) United States
(12) Patent Application Publication
(10) Pub. No.: US 2020/0116610 A1
(43) Pub. Date: Apr. 16, 2020

(54) TESTING SYSTEM AND METHOD FOR MEASURING LOSS OF PARTICLES IN WATER INRUSH PROCESS IN REAL TIME

(71) Applicant: CHINA UNIVERSITY OF MINING AND TECHNOLOGY, Jiangsu (CN)

(72) Inventors: Yingchao WANG, Jiangsu (CN); Fan GENG, Jiangsu (CN); Shengqi YANG, Jiangsu (CN); Qiang ZHANG, Jiangsu (CN); Hongwen JING, Jiangsu (CN); Lijun HAN, Jiangsu (CN); Fanshu MENG, Jiangsu (CN); Ning ZHAO, Jiangsu (CN); Bo MENG, Jiangsu (CN); Qingbin MENG, Jiangsu (CN)

(21) Appl. No.: 16/344,319

(22) PCT Filed: Jul. 6, 2017
(86) PCT No.: PCT/CN2017/092119

§ 371 Date: Apr. 23, 2019

(30) Foreign Application Priority Data
Jun. 14, 2017 (CN) 201710447853.3

(51) Int. Cl. G01N 5/04; G01N 1/34; B07B 1/40; B07B 1/46

(52) U.S. Cl. CPC G01N 5/04; G01N 1/34; B07B 2201/04; B07B 1/4609; B07B 1/40

(57) ABSTRACT

A testing system for measuring loss of soil particles with different particle sizes in a water inrush process includes: a vibration screening apparatus; a water collecting apparatus for collecting the mass of water and transmitting the water to a collecting and calculating apparatus; a conveying apparatus for conveying screened soil particles to a weighing apparatus; a weighing apparatus used for weighing the screened soil particles and transmitting the measured weight of the screened soil particles to the collecting and calculating apparatus; and a collecting and calculating apparatus used for controlling the operation of the testing system, inputting parameters and calculating data. The condition of particle loss in a simulated tunnel water inrush process can be automatically measured in real time, providing a basis for researching the influence caused by the particle sizes of fillings in the water inrush process of the tunnel to water inrush.

### I. TECHNICAL FIELD

The present invention relates to a testing system for automatically measuring loss of particles in a tunnel water inrush testing process in real time, and belongs to the field of model testing of geologic hazards in tunneling works.

### II. BACKGROUND ART

With construction of major infrastructure projects in transportation, and water resource and hydropower, China has become a country with the largest scale of tunnel construction in the world, the difficulty of which is also the highest. Especially, as the construction focus of major projects are moved to western mountainous regions and karst regions where the topographical and geological conditions are extremity complex, deep and long tunneling works with high-risk are being constructed or to be constructed, during the construction of which serious water inrush accidents may occur easily, which seriously affect the safety of tunnel construction.

At present, for collection and analysis of soil particles in the processes of tunnel water inrush simulation experiments, the soil particles are usually collected entirety, and the grading of soil particles at different time points cannot be acquired. Instead, the screening and analysis have to be carried out after the completion of the water inrush process, as is adverse to the analysis of the experimental processes.

Besides, at present, most existing vibratory screening devices have to be operated manually, resulting severe waste of manpower and material resources, and the subsequent processing work is also very tedious. However, the present invention reduces the workload of scientific researchers by fully automated measurement, and various parameters and data are stored automatically and uploaded to a specified receiving system, to facilitate scientific data analysis, comparison and statistics.

Moreover, the weighing history of the conventional weighing devices cannot be stored, and it is inconvenient for subsequent query of the user.

### III. CONTENTS OF THE INVENTION

Object of the Invention: in order to overcome the drawbacks in the prior art, the present invention provides an automatic screening and weighing system that can perform automatic screening and weighing, simulate the loss of soil particles and distribution of water inrush in a tunnel water inrush process, and supports query and analysis of the weighing records at any time.

Technical Scheme: to achieve the object described above, the present invention employs the following technical scheme:

A testing system for measuring the loss of particles in a water inrush process in real time, comprising a vibratory screening device, a water collecting device, a conveying device, a weighing device, and a collecting and computing device, wherein,

the vibratory screening device is configured to screen soil particles lost in the water inrush process by means of vibration;
the water collecting device is configured to collect the water flowing out in the water inrush process, measure the mass of water and transmit the measured mass of water to the collecting and computing device;
the conveying device is configured to convey the screened soil particles to the weighing device; the weighing device is configured to measure the weight of the screened soil particles and transmit the measured weight of the soil particles to the collecting and computing device;
the collecting and computing device is configured to control the operation of the testing system, parameters are inputted into the collecting and computing device, and then the collecting and computing device calculates a general law of distribution of particles in different particle sizes, proportions of loss of particles in different diameters and amount of water loss in each time interval according to the inputted parameters, received mass of water and weight of soil particles;
the vibratory screening device comprises three or more vibratory screening boxes, a drawer-type support, and a screening vibration table; the three or more vibratory screening boxes are disposed on the drawer-type support, the drawer-type support is disposed on the screening vibration table, and the drawer-type support is provided with a water inlet on the top; each vibratory screening box is arranged with a soil particle outlet on a side surface and with a mesh screen mounted inside, a border of the mesh screen intersects with the soil particle outlet, the vibratory screening boxes are arranged from top to bottom in the order of the mesh sizes of corresponding mesh screens, and the bottommost vibratory screening box is arranged with a water outlet at the bottom of a side surface;
the water collecting device comprises a pressure sensor and a water collecting tank, the pressure sensor is disposed at the bottom inside the water collecting tank, and the screening vibration table is mounted on the water collecting tank via a spring;
the conveying device comprises a soil particle conveying channel, a pusher mechanism, and a small platform; the soil particle outlet is connected to an inlet end of the soil particle conveying channel, an outlet end of the soil particle conveying channel is connected to an inlet end of the small platform, and the pusher mechanism is configured to push the soil particles screened by the screening device to the weighing device for measurement;
the weighing device comprises a particle collecting box, an electronic weigher, and a platform support; an outlet end of the small platform is connected to one end of the particle collecting box, the particle collecting box is disposed on the electronic weigher, and the electronic weigher is disposed on the platform support;
the collecting and computing device comprises a controller and a computer storage device, the controller is configured to control the operation of the testing system, and the computer storage device is configured to store and calculate the data transmitted from the electronic weigher and the pressure sensor; the computer storage device is connected to the controller, the controller is connected to the electronic weigher, and the controller is also connected to the screening vibration table, the pusher mechanisms and the pressure sensor.

Preferably, the vibration frequency of the screening vibration table is controlled by the controller, the parameters, including the mesh diameter of the mesh screens and the number of the mesh screens, are inputted into the computer storage device connected via the controller, then the computer storage device calculates a general law of distribution of particles in different particle sizes and the proportion of loss of particles in different particle sizes in each time interval.

Preferably, the pusher mechanism comprises a hair brush, a slide rail, a drive belt, a servo motor, a pair of tension wheels, a driving wheel, a first driven wheel and a second driven wheel; the slide rail is arranged along the mesh screen, the soil particle conveying channel, and the small platform, the driving wheel is fixed to a tail end of the slide rail, the first driven wheel is fixed to the head end of the slide rail, the second driven wheel is fixed to the slide rail where the soil particle conveying channel meets the small platform, the driving wheel is connected to the first driven wheel and the second driven wheel via the drive belt, and the servo motor is connected to the driving wheel via a coupling; the hair brush is slidably connected to the slide rail, one end of the drive belt is fixed to one of the pair of tension wheels, and the other end of the drive belt is fixed to the other one of the pair of tension wheels and the tension wheel is fixed to the hair brush, so that the hair brush reciprocates between the mesh screens and the small platform; the pushing frequency of the pusher mechanism is controlled by the controller.

Preferably, the soil particle conveying channel, the small platform, and the mesh screen are hinged together, so that an inclination angle of the soil particle conveying channel can be adjusted according to the actual requirement.

Preferably, the bottom surface of the bottommost vibratory screening box is arranged at a certain inclination angle, and the lower end of the bottom surface is at the water outlet side, while the higher end of the bottom surface is away from the water outlet side.

Preferably, the vibratory screening boxes are rectangular parallelepiped screening boxes, and the mesh screens are rectangular mesh screens.

Preferably, the mesh screens are made of stainless steel material, and the vibratory screening boxes are made of iron material.

Preferably, the screening vibration table comprises a solenoid.

Preferably, the mesh screens, the conveying devices, and the weighing devices are arranged in one-to-one correspondence.

A testing method for measuring the loss of particles in a water inrush process in real time, comprising the following steps:

(1) placing the apparatus below a water inrush spot, adjusting the number of required vibratory screening boxes and the specification and number of corresponding mesh screens, powering the apparatus so that the apparatus is in a ready state, and inputting the parameters, including the mesh diameter of the mesh screens and the quantity of the mesh screens, into the computer storage device connected via the controller;
(2) lost substances falling into the vibratory screening box from the water inrush spot after water inrush starts and vibrating on the mesh screens continuously, so that soil particles in smaller particle diameter fall to the next mesh screen, and then pushing the soil particles left with the pusher into the corresponding conveying device;
(3) pushing the soil particles at corresponding level with the pusher into the corresponding weighing device, recording the mass of the soil particles with the electronic weigher, and transmitting the data via the controller to the computer storage device;
(4) collecting the water flowing out of the water outlet into the water collecting tank, recording the mass of the water with the pressure sensor at the bottom of the water collecting tank, and transmitting the data to the computer storage device;
(5) when the water inrush completely stops and no more substance is lost, calculating a general law of distribution of particles in different particle sizes, the proportion of loss of particles in different diameter, and the amount of water loss in each time interval, according to the mass data obtained with the electronic weigher and the water mass data obtained with the pressure sensor.

Compared with the prior art, the present invention has the following beneficial effects:

1. In the apparatus according to the present invention, all levels of vibratory screening boxes employ rectangular parallelepiped structures instead of conventional circular structures, which can be opened and closed freely like a drawer. Thus, the mesh screens can be replaced in appropriate specification as required at any time, so that the mesh sizes and number of the mesh screens can be controlled easily, and thereby the practicability is improved.
2. In the present invention, the weighing devices and the water collecting device are connected to the computer storage device, so that data serialization is realized. Thus, the continuous mass variation not only can be obtained but also can be stored, the query and subsequent data analysis, comparison and statistics operations become convenient, and the workload is reduced greatly.
3. The apparatus can perform screening, weighing, and calculation automatically; the soil particle conveying channel, the small platform and the mesh screen are hinged together, and the screening vibration table comprises a solenoid, so that objectives of stable structure, easy to use, easy to disassembly and improved screening and weighing efficiency are attained.
4. The apparatus not only can be used to measure the distribution of loss of different solid particles in a simulated tunnel water inrush test, but also can be used to measure the grading analysis of other solid particles, and has a wide range of application.

### IV. DESCRIPTION OF DRAWINGS

FIG. 1 shows the testing system for measuring the loss of particles in a water inrush process in real time according to the present invention;

FIG. 2 shows the screening device and the water collecting device in the testing system for measuring the loss of particles in a water inrush process in real time according to the present invention;

FIG. 3 shows the conveying devices, the weighing devices, and the collecting and computing device in the testing system for measuring the loss of particles in a water inrush process in real time according to the present invention.

In the figures: 1—mesh screen; 2—vibratory screening box; 3—screening vibration table; 4—soil particle conveying channel; 5—pusher mechanism; 6—particle collecting box; 7—electronic weigher; 8—small platform; 9—computer storage device; 10—controller; 11—water outlet

### V. EMBODIMENTS

Hereunder the present invention will be further detailed with reference to the accompanying drawings and embodiments. It should be appreciated that these embodiments are only used for describing the present invention and not used for limiting the scope of the present invention. The person skilled in the art can make various equivalent modifications to the embodiments after reading the present invention, which shall be deemed as falling into the scope of the claims.

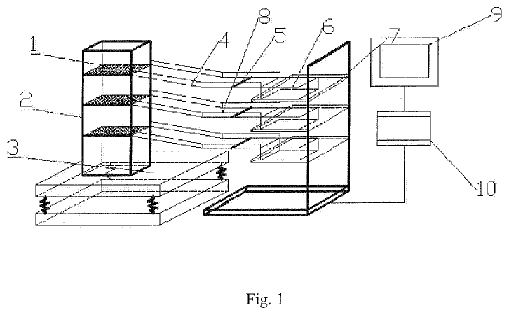

FIG. 1 shows a testing system for measuring the loss of particles in a water inrush process in real time, comprising a vibratory screening device, a water collecting device, a conveying device, a weighing device, and a collecting and computing device, wherein,

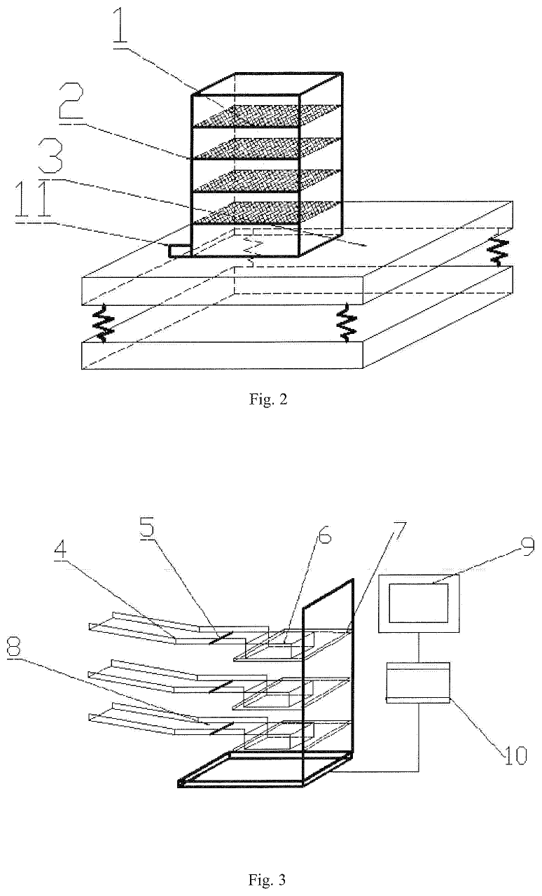

the vibratory screening device is configured to screen soil particles lost in the water inrush process by means of vibration;
the water collecting device is configured to collect the water flowing out in the water inrush process, measure the mass of water and transmit the measured mass of water to the collecting and computing device;
the conveying device is configured to convey the screened soil particles to the weighing device;
the weighing device is configured to measure the weight of the screened soil particles and transmit the measured weight of the soil particles to the collecting and computing device;
the collecting and computing device is configured to control the operation of the testing system, parameters are inputted into the collecting and computing device, and then the collecting and computing device calculates a general law of distribution of particles in different particle sizes, proportions of loss of particles in different diameters and amount of water loss in each time interval according to the inputted parameters, received mass of water and weight of soil particles;
as shown in FIG. 2, the vibratory screening device comprises three vibratory screening boxes 2, a drawer-type support, and a screening vibration table 3; the three vibratory screening boxes 2 are disposed on the drawer-type support, the drawer-type support is disposed on the screening vibration table 3, and the drawer-type support is provided with a water inlet on the top; each vibratory screening box 2 is arranged with a soil particle outlet on a side surface and with a mesh screen 1 mounted inside, a border of the mesh screen 1 intersects with the soil particle outlet, the vibratory screening boxes 2 are arranged from top to bottom in the order of the mesh sizes of corresponding mesh screens 1, and the bottommost vibratory screening box 2 is arranged with a water outlet at the bottom of a side surface; the bottom surface of the bottommost vibratory screening box is arranged at a certain inclination angle, and the lower end of the bottom surface is at the water outlet side, while the higher end of the bottom surface is away from the water outlet side; the number of the mesh screens 1 and the mesh sizes of the mesh screens 1 are adjustable, and the mesh diameter parameter of the mesh screens 1 may be inputted into the computer storage device 9 connected via the controller 10, so that the computer storage device 9 uses the inputted parameters to calculate a general law of distribution of particles in different particle sizes and the proportions of loss of particles in different particle sizes in each time interval. The vibratory screening boxes 2 are rectangular parallelepiped screen boxes, and the mesh screens 1 are rectangular mesh screens, which can be opened and closed freely like a drawer. Because of the participation of water, the rectangular mesh screens 1 are made of stainless steel material, and the vibratory screening boxes 2 are made of iron material; moreover, in order to prevent the vibratory screening boxes 2 from getting instable due to vibration in the screening process, the screening vibration table 3 has a magnetic effect after energizing, so that the apparatus is kept stable.
the water collecting device comprises a pressure sensor and a water collecting tank, the pressure sensor is disposed at the bottom inside the water collecting tank, and the screening vibration table 3 is mounted on the water collecting tank via a spring;
as shown in FIG. 3, the conveying device comprises a soil particle conveying channel 4, a pusher mechanism 5, and a small platform 8; the soil particle outlet is connected to an inlet end of the soil particle conveying channel 4, an outlet end of the soil particle conveying channel 4 is connected to an inlet end of the small platform 8, and the pusher mechanism 5 is configured to push the soil particles screened by the screening device to the weighing device for measurement; the pusher mechanism 5 comprises a hair brush, a slide rail, a drive belt, a servo motor, a pair of tension wheels, a driving wheel, a first driven wheel and a second driven wheel; the slide rail is arranged along the mesh screen 1, the soil particle conveying channel 4, and the small platform 8, the driving wheel is fixed to a tail end of the slide rail, the first driven wheel is fixed to the head end of the slide rail, the second driven wheel is fixed to the slide rail where the soil particle conveying channel meets the small platform, the driving wheel is connected to the first driven wheel and the second driven wheel via the drive belt, and the servo motor is connected to the driving wheel via a coupling; the hair brush is slidably connected to the slide rail, one end of the drive belt is fixed to one of the pair of tension wheels, and the other end of the drive belt is fixed to the other one of the pair of tension wheels and the tension wheel is fixed to the hair brush, so that the hair brush reciprocates between the mesh screens 1 and the small platform 8; the addition of the small platform 8 allows large particles to fall down from the soil particle conveying channel without directly impacting the particle collecting boxes and causing over-weight display on the electronic weigher. The soil particle conveying channel 4, the small platform 8, and the mesh screen 1 are hinged together, so that an inclination angle of the soil particle conveying channel 4 can be adjusted according to the actual requirement.

The weighing device comprises a particle collecting box 6, an electronic weigher 7, and a platform support; an outlet end of the small platform 8 is connected to one end of the particle collecting box 6, the particle collecting box 6 is disposed on the electronic weigher 7, and the electronic weigher 7 is disposed on the platform support; the mesh screens 1, the conveying devices, and the weighing devices are arranged in one-to-one correspondence;

the collecting and computing device comprises a controller 10 and a computer storage device 9, the controller is configured to control the operation of the testing system, and the computer storage device is configured to store and calculate the data transmitted from the electronic weigher and the pressure sensor; the computer storage device 9 is connected to the controller 10, the controller 10 is connected to the electronic weigher 7, and the controller 10 is also connected to the screening vibration table 3, the pusher mechanisms 5 and the pressure sensor.

The lost soil particles to be screened by the vibratory screening device are provided by the water inrush test, wherein, the screening device should be disposed right below the water inrush spot, to ensure that the lost water and soil particles fall to the central part of the screening device; rectangular mesh screens 1 in different mesh diameters should be provided flexibly according to the specific requirements of the screening scheme to meet the requirements of the field experiment; the soil particles screened through a mesh screen within a time interval are pushed by the pusher mechanism 5 to a respective weighing device, wherein, the moving frequency of the pusher mechanism 5 may be controlled by the controller 10, and the vibration frequency of the screening vibration table 3 may be adjusted by the controller 10.

In addition, the total amount of the inrush water is an indispensable data. Therefore, a water outlet is arranged at the bottom of the screening device to collect the inrush water. To obtain the amount of the inrush water in each time interval of the water inrush process, the bottom surface of the bottommost vibratory screening box is arranged at a certain inclination angle, and a water collecting tank is provided below the water collecting device, the data is recorded in real time by a pressure sensor, transmitted to the storage device and used together with the mass of the particles for analysis and calculation. The particle collecting box 6 is disposed on the electronic weigher 7, the data is recorded every five seconds, and then is transmitted and recorded as digital signals.

A testing method for measuring the loss of particles in a water inrush process in real time, comprising the following steps:

(1) placing the apparatus below a water inrush spot, adjusting the number of required vibratory screening boxes 2 and the specification and number of corresponding mesh screens 1, powering the apparatus so that the apparatus is in a ready state, and inputting the parameters, including the mesh diameter of the mesh screens 1 and the quantity of the mesh screens 1, into the computer storage device 9 connected via the controller 10;
(2) lost substances falling into the vibratory screening box 2 from the water inrush spot after water inrush starts and vibrating on the mesh screens 1 continuously, so that soil particles in smaller particle diameter fall to the next mesh screen 1, and then pushing the soil particles left with the pusher 5 into the corresponding conveying device;
(3) pushing the soil particles at corresponding level with the pusher 5 into the corresponding weighing device, recording the mass of the soil particles with the electronic weigher 7, and transmitting the data via the controller 10 to the computer storage device 9;
(4) collecting the water flowing out of the water outlet into the water collecting tank, recording the mass of the water with the pressure sensor at the bottom of the water collecting tank, and transmitting the data to the computer storage device 9;
(5) when the water inrush completely stops and no more substance is lost, calculating a general law of distribution of particles in different particle sizes, the proportion of loss of particles in different diameter, and the amount of water loss in each time interval, according to the mass data obtained with the electronic weigher and the water mass data obtained with the pressure sensor.

The system not only can be used to automatically measure the mass of particles in different particle sizes in a water inrush process in real time, but also can be used to measure the grading analysis of other solid particles, simply by selecting mesh screens 1 in appropriate specification according to the object to be screened. If only the grading of particles of a sample needs to be measured, the weighing devices, the water collecting device, the conveying devices and the collecting and computing device can be removed, and only the screening device is left. After the screening operation is finished, the particles on the respective mesh screen 1 may be poured onto the electronic weigher 7 and weighed.

The above mentioned is only a preferred embodiment of the present invention, and it should be noted that the person skilled in the art can make various improvements and modifications without departing from the principle of the present invention, and these improvements and modifications should be deemed as falling into the scope of protection of the present invention.

1-10. (canceled)

11. A testing system for measuring the loss of particles in a water inrush process in real time comprising:
a vibratory screening device configured to screen soil particles lost in the water inrush process;
a water collecting device configured to collect the water flowing out in the water inrush process, measure the mass of water and transmit the measured mass of water to the collecting and computing device;
a conveying device configured to convey the screened soil particles to the weighing device;
a weighing device configured to measure the weight of the screened soil particles and transmit the measured weight of the soil particles to the collecting and computing device; and
a collecting and computing device configured to control the operation of the testing system, parameters are inputted into the collecting and computing device, and then the collecting and computing device calculates a general law of distribution of particles in different particle sizes, proportions of loss of particles in different diameters and amount of water loss in each time interval according to the inputted parameters, received mass of water and weight of soil particles;
wherein: the vibratory screening device comprises three or more vibratory screening boxes, a drawer-type support, and a screening vibration table; the three or more vibratory screening boxes are disposed on the drawer-type support, the drawer-type support is disposed on the screening vibration table, and the drawer-type support is provided with a water inlet on the top; each vibratory screening box is arranged with a soil particle outlet on a side surface and with a mesh screen mounted inside, a border of the mesh screen intersects with the soil particle outlet, the vibratory screening boxes are arranged from top to bottom in the order of the mesh sizes of corresponding mesh screens, and the bottommost vibratory screening box is arranged with a water outlet at the bottom of a side surface;
the water collecting device comprises a pressure sensor and a water collecting tank, the pressure sensor is disposed at the bottom inside the water collecting tank, and the screening vibration table is mounted on the water collecting tank via a spring;
the conveying device comprises a soil particle conveying channel, a pusher mechanism, and a small platform; the soil particle outlet is connected to an inlet end of the soil particle conveying channel, an outlet end of the soil particle conveying channel is connected to an inlet end of the small platform, and the pusher mechanism is configured to push the soil particles screened by the screening device to the weighing device for measurement;
the weighing device comprises a particle collecting box, an electronic weigher, and a platform support; an outlet end of the small platform is connected to one end of the particle collecting box, the particle collecting box is disposed on the electronic weigher, and the electronic weigher is disposed on the platform support;
the collecting and computing device comprises a controller and a computer storage device, the controller is configured to control the operation of the testing system, and the computer storage device is configured to store and calculate the data transmitted from the electronic weigher and the pressure sensor; the computer storage device is connected to the controller, the controller is connected to the electronic weigher, and the controller is also connected to the screening vibration table, the pusher mechanisms and the pressure sensor.

12. The testing system according to claim 11, wherein the vibration frequency of the screening vibration table is controlled by the controller, the parameters, including the mesh diameter of the mesh screens and the number of the mesh screens, are inputted into the computer storage device connected via the controller, then the computer storage device calculates a general law of distribution of particles in different particle sizes and the proportion of loss of particles in different particle sizes in each time interval.

13. The testing system according to claim 11, wherein the pusher mechanism comprises a hair brush, a slide rail, a drive belt, a servo motor, a pair of tension wheels, a driving wheel, a first driven wheel and a second driven wheel; the slide rail is arranged along the mesh screen, the soil particle conveying channel, and the small platform, the driving wheel is fixed to a tail end of the slide rail, the first driven wheel is fixed to the head end of the slide rail, the second driven wheel is fixed to the slide rail where the soil particle conveying channel meets the small platform, the driving wheel is connected to the first driven wheel and the second driven wheel via the drive belt, and the servo motor is connected to the driving wheel via a coupling; the hair brush is slidably connected to the slide rail, one end of the drive belt is fixed to one of the pair of tension wheels, and the other end of the drive belt is fixed to the other one of the pair of tension wheels and the tension wheel is fixed to the hair brush, so that the hair brush reciprocates between the mesh screens and the small platform; the pushing frequency of the pusher mechanism is controlled by the controller.

14. The testing system according to claim 11, wherein the soil particle conveying channel, the small platform, and the mesh screen are hinged together, so that an inclination angle of the soil particle conveying channel can be adjusted according to the actual requirement.

15. The testing system according to claim 11, wherein the bottom surface of the bottommost vibratory screening box is arranged at a set inclination angle, and the lower end of the bottom surface is at the water outlet side, while the higher end of the bottom surface is away from the water outlet side.

16. The testing system according to claim 11, wherein the vibratory screening boxes are rectangular parallelepiped screening boxes, and the mesh screens are rectangular mesh screens.

17. The testing system according to claim 11, wherein the mesh screens are made of stainless steel material, and the vibratory screening boxes are made of iron material.

18. The testing system according to claim 11, wherein the screening vibration table comprises a solenoid.

19. The testing system according to claim 11, wherein the mesh screens, the conveying devices, and the weighing devices are arranged in one-to-one correspondence.

20. A testing method for measuring the loss of particles in a water inrush process in real time by utilizing the testing system according to claim 11, comprising the following steps:
(1) placing the apparatus below a water inrush spot, adjusting the number of required vibratory screening boxes and the specification and number of corresponding mesh screens, powering the apparatus so that the apparatus is in a ready state, and inputting the parameters, including the mesh diameter of the mesh screens and the quantity of the mesh screens, into the computer storage device connected via the controller;
(2) lost substances falling into the vibratory screening box from the water inrush spot after water inrush starts and vibrating on the mesh screens continuously, so that soil particles in smaller particle diameter fall to the next mesh screen, and then pushing the soil particles left with the pusher into the corresponding conveying device;
(3) pushing the soil particles at corresponding level with the pusher into the corresponding weighing device, recording the mass of the soil particles with the electronic weigher, and transmitting the data via the controller to the computer storage device;
(4) collecting the water flowing out of the water outlet into the water collecting tank, recording the mass of the water with the pressure sensor at the bottom of the water collecting tank, and transmitting the data to the computer storage device; and
(5) when the water inrush completely stops and no more substance is lost, calculating a general law of distribution of particles in different particle sizes, the proportion of loss of particles in different diameter, and the amount of water loss in each time interval, according to the mass data obtained with the electronic weigher and the water mass data obtained with the pressure sensor.
